(19) United States
(12) Patent Application Publication
(10) Pub. No.: US 2009/0250141 A1
(43) Pub. Date: Oct. 8, 2009

(54) FLAT BAMBOO ELEMENT FABRICATION METHOD

(76) Inventor: Wen-Tsan WANG, Taipei City (TW)

Correspondence Address: LEONG C LEI, PMB # 1008, 1867 YGNACIO VALLEY ROAD, WALNUT CREEK, CA, 94598, US

(21) Appl. No.: 12/098,470

(22) Filed: Apr. 7, 2008

(51) Int. Cl. B27J 1/00

(52) U.S. Cl. 144/333; 144/360

(57) ABSTRACT

A flat bamboo element fabrication method for making flat bamboo elements by trimming prepared bamboo cane and cutting the trimmed bamboo cane into a number of bamboo bars of equal length and width and then delivering each bamboo bar through the gap in between the bottom ramming roller and upper ramming roller of a ramming machine for ramming into a flat bamboo element that has a crack pattern therein. In an alternate form, the upper ramming roller has parallel circular cutter blades for cutting each rammed flat bamboo bar into multiple flat bamboo elements.

### BACKGROUND OF THE INVENTION

(a) Technical Field of the Invention

The present invention relates to the processing of bamboo materials and more particularly, to a method of processing raw bamboo canes into flat bamboo elements.

(b) Description of the Prior Art

Various materials including ceramics, glass, wood, plastics, stainless steel, and etc. may be used for making wall panels for storage containers for keeping things. Recently, bamboo materials are intensively used for making furniture for the advantage of causing a sense of antique beauty.

Because a bamboo stick has a circular cross section, using a bamboo material to make bamboo slat or plate members needs to overcome the problem of the curved surface of the bamboo material. Therefore, the fabrication of bamboo-based plate members is complicated. A bamboo slat or plate member may be prepared subject to one of the following two ways: The first way is to cut well-dried bamboo canes into small bamboo strips, and then to bond a number of bamboo strips into a bamboo slat or plate member by means of a compression bonding process, and then cut the bamboo plate subject to the desired shape. The second way is to crush bamboo canes into chips, and then to mix the bamboo chips with an adhesive, and then to mold the mixture into bamboo slat or plate members through a thermal compression molding process, and then to cut the bamboo slat or plate members subject to the desired shape. According to the aforesaid prior art processing processes, the fabrication of bamboo slat or plate members require much labor and time. Because the aforesaid conventional bamboo slat or plate member fabrication methods cannot be performed by means of an automatic machine for mass production, the cost of the finished products is high. Except labor and time consuming, the aforesaid conventional bamboo plate member fabrication methods have further drawbacks of high material loss and high consumption of energy and the use of adhesive may cause environmental pollution.

### SUMMARY OF THE INVENTION

The primary purpose of the present invention is to provide a flat bamboo element fabrication method that eliminates the use of an adhesive, reduces the consumption of energy, simplifies the flat bamboo element processing process, and saves much labor and time.

According to one embodiment of the present invention, prepared bamboo canes are trimmed and then cut longitudinally into cane into a number of bamboo bars of equal length and width, and then each bamboo bar is delivered through the gap in between the bottom ramming roller and upper ramming roller of a ramming machine and then rammed into a flat bamboo element that has a crack pattern therein. In an alternate form, the upper ramming roller has parallel circular cutter blades for cutting each rammed flat bamboo bar into multiple flat bamboo elements.

According to a second embodiment of the present invention, the upper ramming roller of the ramming machine has a plurality of circular cutter blades arranged in parallel around the periphery. When one bamboo bar is delivered through the gap in between the upper ramming roller and the bottom ramming roller, the bamboo bar is rammed and simultaneously cut into multiple narrow, elongated, flat bamboo elements.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic drawing showing a well-dried bamboo cane cut in longitudinal direction according to the present invention.

FIG. 2 an elevational view of a bamboo bar cut from a bamboo cane according to the present invention.

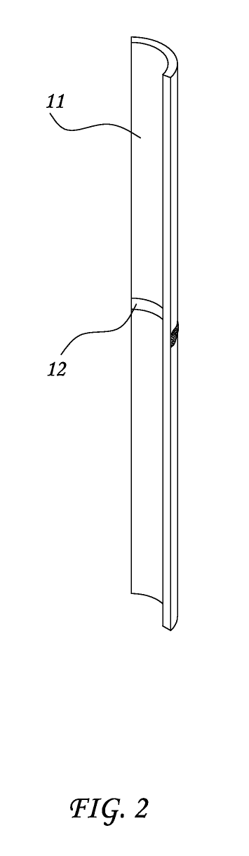

FIG. 3 is a schematic drawing showing a bamboo bar set between the bottom ramming roller and upper ramming roller of a roller ramming machine and the upper roller ramming roller kept spaced above the bottom ramming roller at a distance before operation according to the present invention.

FIG. 4 corresponds to FIG. 3, showing the upper ramming roller pressed on the bamboo bar against the bottom ramming roller during rotation of the upper ramming roller and the bottom ramming roller.

FIG. 5 corresponds to FIG. 4, showing the bamboo bar rammed into a flat manner and cut into multiple narrow, elongated, flat bamboo elements.

FIG. 6 illustrates narrow, elongated flat bamboo elements obtained according to the present invention.

FIG. 7 is a schematic drawing showing a bamboo bar set between the bottom ramming roller and plain upper ramming roller of a roller ramming machine and the plain upper roller ramming roller kept spaced above the bottom ramming roller at a distance before operation according to the present invention.

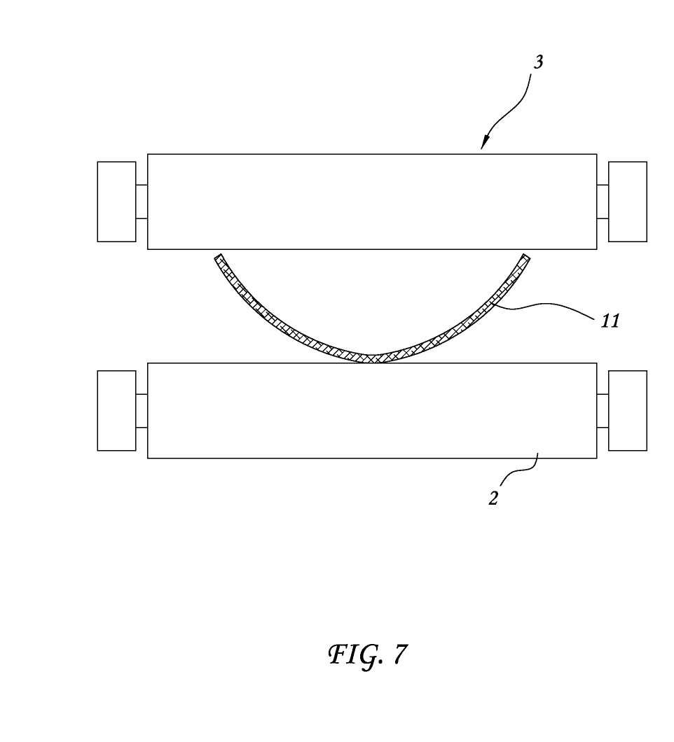

FIG. 8 corresponds to FIG. 7, showing the bamboo bar rammed into a flat manner.

FIG. 9 is an oblique elevation of a flat bamboo element with crack pattern made according to the present invention.

FIG. 10 is an oblique elevation of a bamboo bucket made of narrow, elongated, flat bamboo elements prepared according to the present invention.

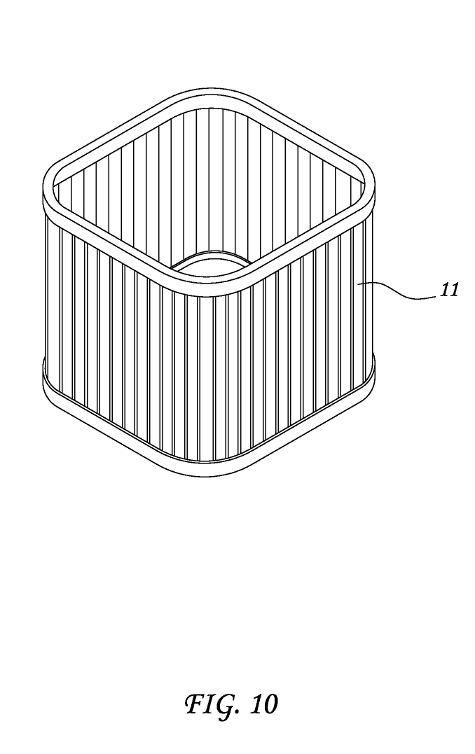

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The invention provides a flat bamboo element fabrication method to process bamboo canes into flat bamboo elements. Bamboo canes are cut subject to the desired length, and then trimmed to smoothen the surface, and then the trimmed bamboo canes are longitudinally cut into bamboo bars for processing into flat bamboo elements.

A flat bamboo element fabrication method in accordance with a first embodiment of the present invention is adapted for processing the lower or middle part of each bamboo can that has a relatively greater diameter, and the method includes the steps of:

### Prepare a Predetermined Length of Bamboo Cane;

Trim the knot of the bamboo cane to smoothen the outer surface of the bamboo cane;

Cut the trimmed bamboo cane along its length into a number of bamboo bars of equal length and width;

Prepare a roller ramming machine comprising a bottom ramming roller and an upper ramming roller that has circular cutter blades arranged in parallel around the periphery, and then deliver each bamboo bar thus obtained from step c. through the gap in between the bottom ramming roller and the upper ramming roller during rotation of the bottom ramming roller and the upper ramming roller for enabling each bamboo bar to be cut into multiple narrow, elongated, flat bamboo elements and simultaneously rammed into a flat manner.

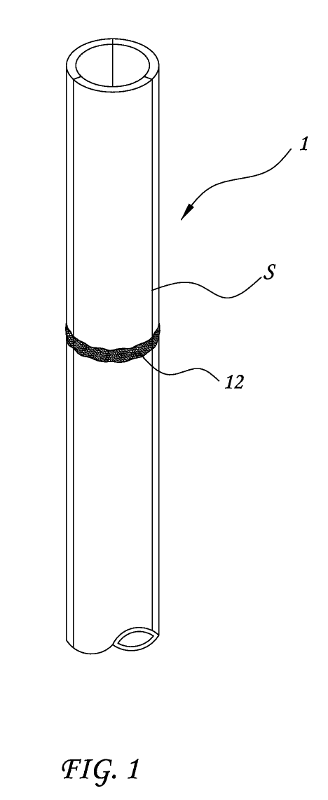

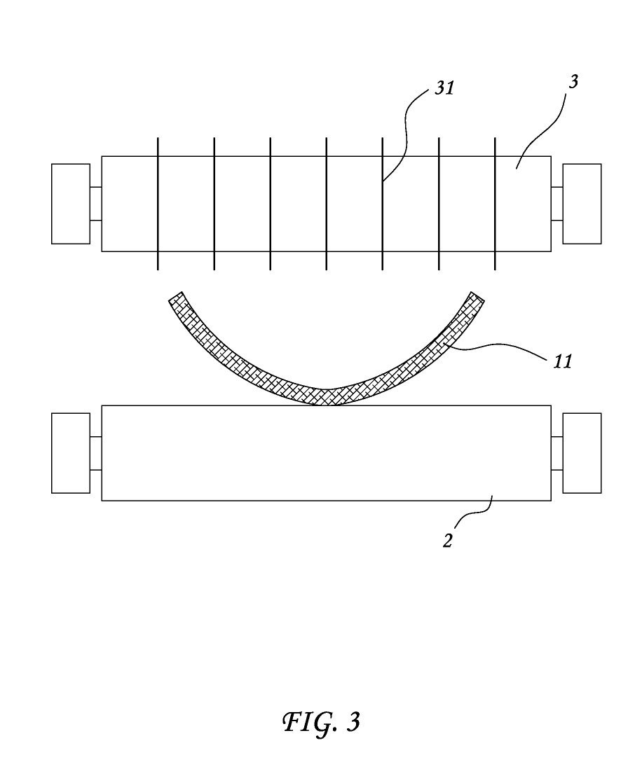

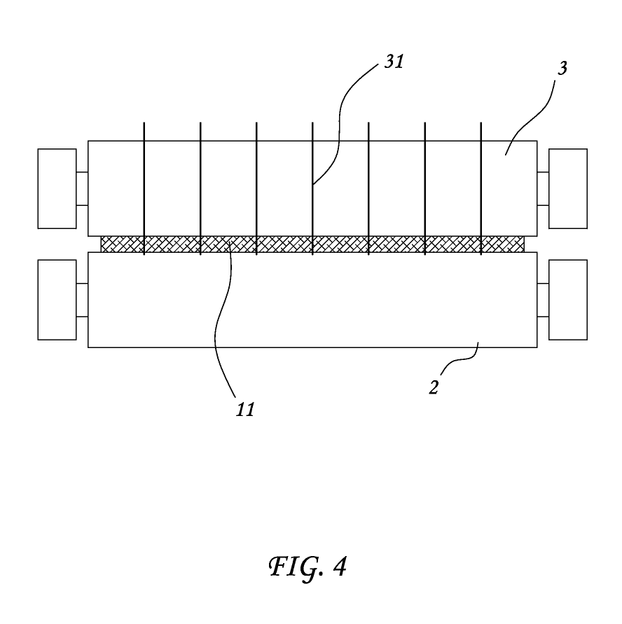

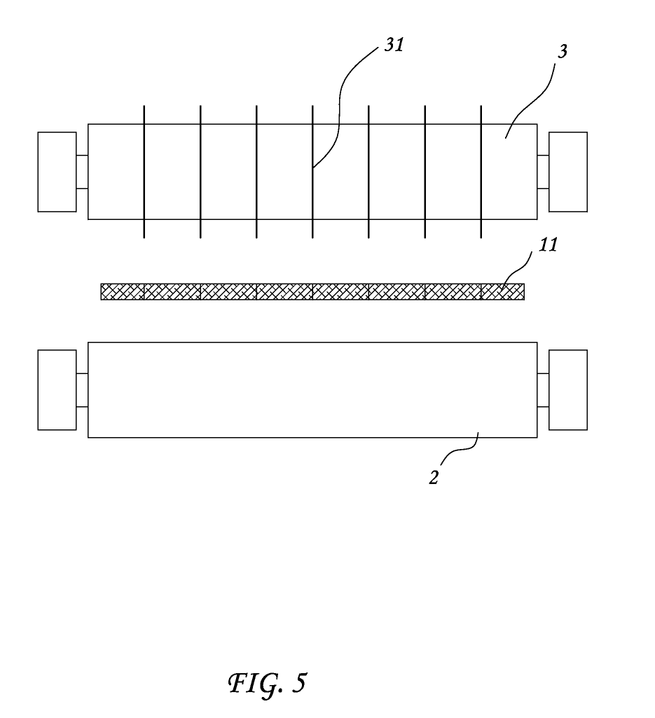

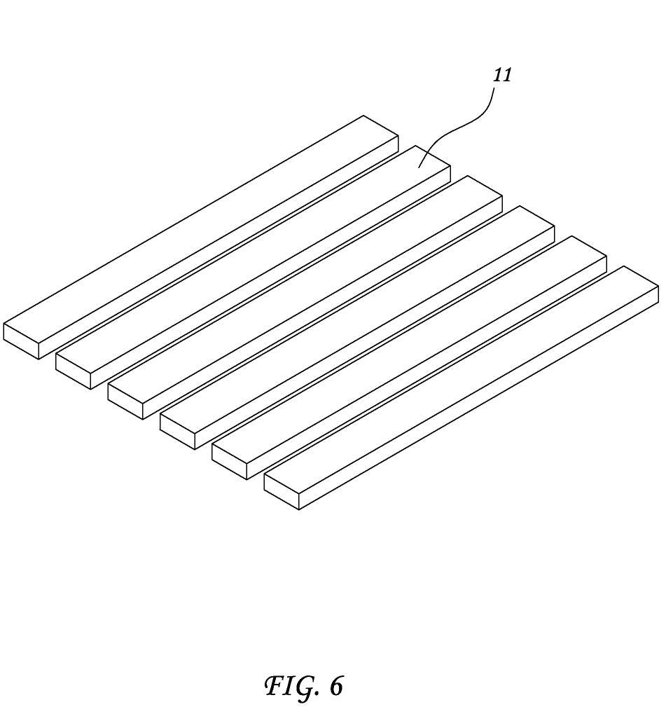

As shown in FIG. 1, a predetermined length of bamboo cane 1 is prepared (step a) and peripherally trimmed (step b), and then cut along its length S into a number of bamboo bars 11 that have a same length and width and a smoothly arched cross section (Step c). The main feature of the present invention is to process each transversely arched bamboo bar into multiple flat bamboo elements. Therefore, the invention provides a roller ramming machine that comprises a bottom ramming roller 2 and an upper ramming roller 3 (see FIG. 3). The bottom ramming roller 2 and the upper ramming roller 3 are cylindrical ramming rollers. Further, the upper ramming roller 3 has circular cutter blades 31 arranged in parallel around the periphery. During the operation of the roller ramming machine to rotate the bottom ramming roller 2 and the upper ramming roller 3, each transversely arched bamboo bar 1 is longitudinally moved through the gap in between the bottom ramming roller 2 and the upper ramming roller 3 (see FIG. 4) and therefore each transversely arched bamboo bar 1 is rammed into a flat manner and cut by the circular cutter blades 31 into multiple flat bamboo elements (see FIGS. 5 and 6).

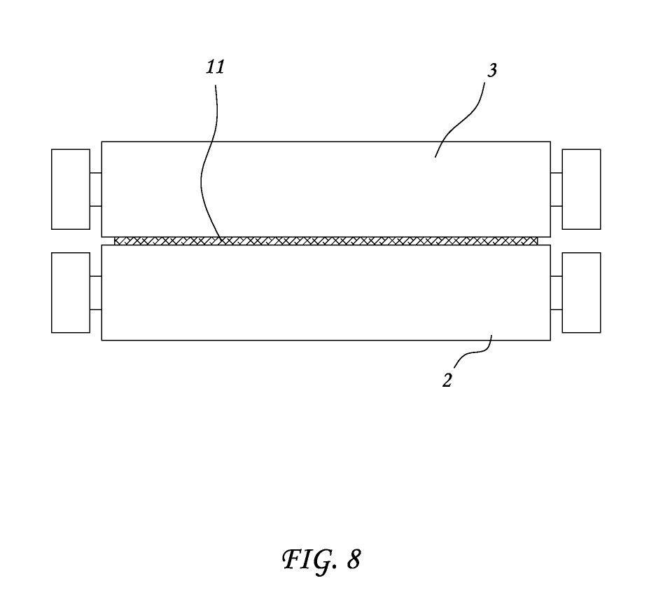

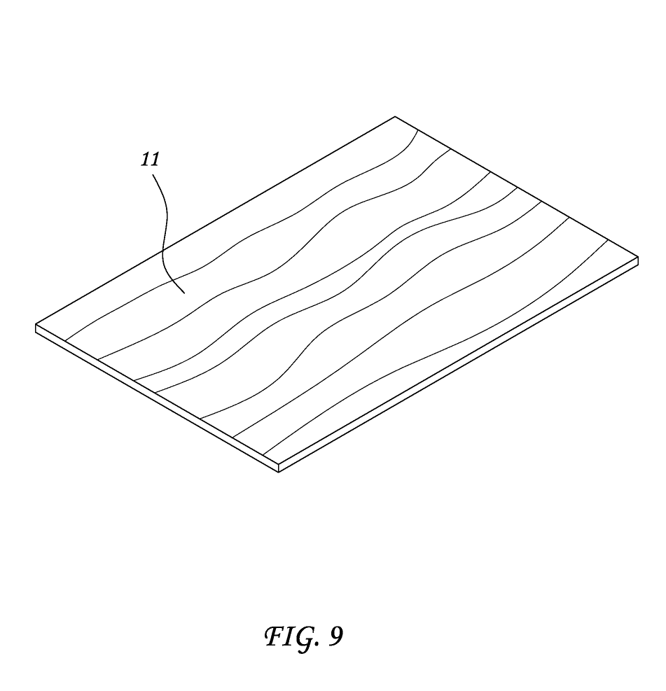

In an alternate form of the present invention, a predetermined length of bamboo cane that has a relatively smaller diameter (for example, the upper part of the cane of a bamboo tree is prepared and then trimmed and cut along its length into a number of bamboo bars of equal length and width, and then each bamboo bar thus obtained is delivered through the gap in between the bottom ramming roller 2 and upper ramming roller 3. However, the bottom ramming roller 2 and upper ramming roller 3 of the roller ramming machine according to this embodiment are cylindrical ramming rollers, and the upper ramming roller 3 is a plain ramming roller without the aforesaid cutter blades 31. When one bamboo bar 11 is delivered through the gap in between the bottom ramming roller 2 and upper ramming roller 3 (see FIG. 8), the bamboo bar 11 is rammed to crack, forming a flat bamboo element that has a crack pattern therein (see FIG. 9). The cracked flat bamboo element 11 can be utilized as a filling material for compression molding plate members.

The narrow, elongated, flat bamboo elements made according to the present invention can be used for making buckets, cabinets, storage boxes, and any of a variety of other furniture.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A flat bamboo element fabrication method comprising the steps of:
a) preparing a predetermined length of bamboo cane;
b) trimming each knot of the prepared bamboo cane to smoothen the outer surface of the bamboo cane;
c) cutting the trimmed bamboo cane along the length thereof into a number of bamboo bars that are equal in length and width;
d) preparing a roller ramming machine, which comprises a bottom ramming roller and an upper ramming roller that has a plurality of circular cutter blades arranged in parallel around the periphery thereof, and then rotating said upper ramming roller and said bottom ramming roller and delivering each bamboo bar thus obtained from step c). through the gap in between said bottom ramming roller and said upper ramming roller during rotation of said bottom ramming roller and said upper ramming roller for enabling each bamboo bar to be rammed and cut into multiple narrow, elongated, flat bamboo elements.

2. A flat bamboo element fabrication method comprising the steps of:
a) preparing a predetermined length of bamboo cane;
b) trimming each knot of the prepared bamboo cane to smoothen the outer surface of the bamboo cane;
c) cutting the trimmed bamboo cane along the length thereof into a number of bamboo bars that are equal in length and width;
d) preparing a roller ramming machine, which comprises a bottom ramming roller and an upper ramming roller, and then rotating said upper ramming roller and said bottom ramming roller and delivering each bamboo bar thus obtained from step c). through the gap in between said bottom ramming roller and said upper ramming roller during rotation of said bottom ramming roller and said upper ramming roller for enabling each bamboo bar to be rammed into a flat bamboo element that has a crack pattern therein.
